(19) United States
(12) Patent Application Publication
(10) Pub. No.: US 2002/0022409 A1
(43) Pub. Date: Feb. 21, 2002

(54) CORROSION RESISTANT BATTERY TERMINAL

(76) Inventor: ROBERT M. CARIDEI, BLUFF CITY, TN (US)

Correspondence Address: ALEX CHARTOVE, MORRISON & FOERSTER, LLP, 2000 PENNSYLVANIA AVENUE, NW, WASHINGTON, DC, 20006-1888, US

(21) Appl. No.: 08/311,902

(22) Filed: Sep. 26, 1994

Related U.S. Application Data
(63) Continuation of application No. 07/525,169, filed on May 16, 1990, now abandoned.

(51) Int. Cl. H01R 4/42; B32B 15/08; B32B 27/38; B32B 27/40

(52) U.S. Cl. 439/764; 439/491; 439/522; 439/763; 428/418; 428/425.8; 428/458

(57) ABSTRACT

A coated battery terminal for protection from corrosion. A non-conductive coating is deposited on all outer surfaces of a battery terminal which prevents the terminal from being exposed to the hostile environment which lead acid batteries are subject, thus increasing battery terminal life. The coating can be color-coded to assist in polarity identification. The coating eases clean-up and decreases maintenance of the battery terminals.

### BACKGROUND OF THE INVENTION

1. Field of the Invention

The present invention is directed to storage battery terminals, and more particularly, to a battery terminal which prevents corrosion.

2. Description of the Prior Art

Terminal corrosion has continually plagued the industry. The electrolyte used in most SLI (starting, lighting, ignition) storage batteries contains sulfuric acid. During the constant charging/discharging cycle, a battery out-gasses sulfuric acid aerosol. The battery terminals' proximity to the vent caps results in their exposure to the sulfuric acid. Further, the battery terminals may come in contact with the sulfuric acid during maintenance, when electrolyte may be spilt on them, or as a result of battery movement. The unprotected battery terminals are also subject to other corrosive elements like water and road salts.

Besides the previously mentioned chemical corrosion, an electrochemical corrosion usually occurs because of the dissimilar metals. Battery posts are typically lead, while battery cables are copper. Most battery terminals are made of lead or copper, and some are tin plated. Further, the bolt and nut used to tighten the terminal around the battery terminal post are usually made of zinc plated steel.

Corrosion pits the battery terminal, and this loss of metal causes an associated reduction in electrical conductivity. This loss of conductivity may cause sparking and lead to damage of the battery and/or the vehicle in which it is installed. Eventually, all conductivity will be lost and the battery terminal must be replaced.

There have been many attempts to prevent this corrosion process. The usual method is to plate a copper terminal with either lead or tin, although it is not a settled matter as to which is better. Tin is a better conductor than lead, but is inferior from an electrochemical corrosion standpoint. Other solutions have included applying silicon or grease to the terminals, but this reduces conductivity and retains foreign substances which come in contact with the terminals.

Sometimes a plastic or rubber sheath, attached to the cable, is used to cover the terminal. This does not form a tight seal which will prevent liquids and other foreign materials from touching the battery terminals. Further, these sheaths hinder access to the terminals when maintenance must be performed and, thus, are not always desirable.

### SUMMARY OF THE INVENTION

The present invention concerns a non-conductive coating on battery terminals to protect the terminal from corrosion.

For purposes of clarity in this application, the term “terminal” refers to the connector between a battery cable and a lead battery post, rather than the connector and post as a single unit. The terminals or connectors are made of electrically conductive materials, such as lead or copper. A battery cable is inserted into one end of the connector, and the connector is then crimped or screws are used to physically secure the cable, and to make an electrical contact.

The other end of the connector is formed to encircle a cylindrical battery post, and has a bolt and nut or other similar means for tightening the connector around the post so that electrical contact is made.

Exposed metals are subject to corrosion; this is particularly so with battery terminals, considering the hostile environment in which they are placed. Consequently, a non-conductive coating is applied to the terminals. The easiest method of applying such non-conductive coating is through an electrostatic spraying technique. The coating covers all outer surfaces of the battery terminal, leaving exposed only the areas needed to make electrical contact with the battery post and the battery cable. The coatings on the battery terminals are color-coded to distinguish between the positive and negative terminals. This decreases the chances for connecting a terminal to the wrong battery post and aids in trouble shooting a problem with the electrical system.

A safety benefit from having a non-conductive coating on the battery terminals is that it prevents jump starts when jumper cables are attached directly to the battery. It is recommended for jump starting a vehicle that the negative clamp be attached to the engine block and the positive clamp be attached to the solenoid. Hydrogen and oxygen gas are constantly vented from lead acid batteries, and are easily ignited. Thus, if jumper cables are attached directly to the battery, the proximity of sparks at the jumper clamps to these gases creates a safety hazard. However, with these coated terminals, all outer surfaces of the battery terminals are coated with the non-conductive material, therefore frustrating any misguided attempt to jump start a vehicle using this dangerous arrangement. One is forced to use a safer, more remote, contact point. Hence, using coated battery terminals helps to eliminate a safety hazard.

An objective of the present invention is to prevent battery terminal corrosion by coating the terminal with a non-conductive coating.

Another object of the invention is to color-code the battery terminals for easier identification of the different polarities.

Another object of the invention is to simplify cleaning and maintaining the battery terminals by having a coating which does not interfere with the normal handling procedures of a terminal nor retain foreign objects with which it comes in contact.

Other objects, features, and advantages of this invention will become apparent from the following description of the preferred embodiment with reference to the accompanying drawings.

### BRIEF DESCRIPTION OF THE DRAWINGS

FIG. 1 is the electrostatic spray set-up used to apply a non-conductive coating.

FIG. 2 is a top view of a typical battery terminal.

FIG. 3 is a partial cross-sectional view taken along line A-A of FIG. 2.

### DETAILED DESCRIPTION OF THE INVENTION

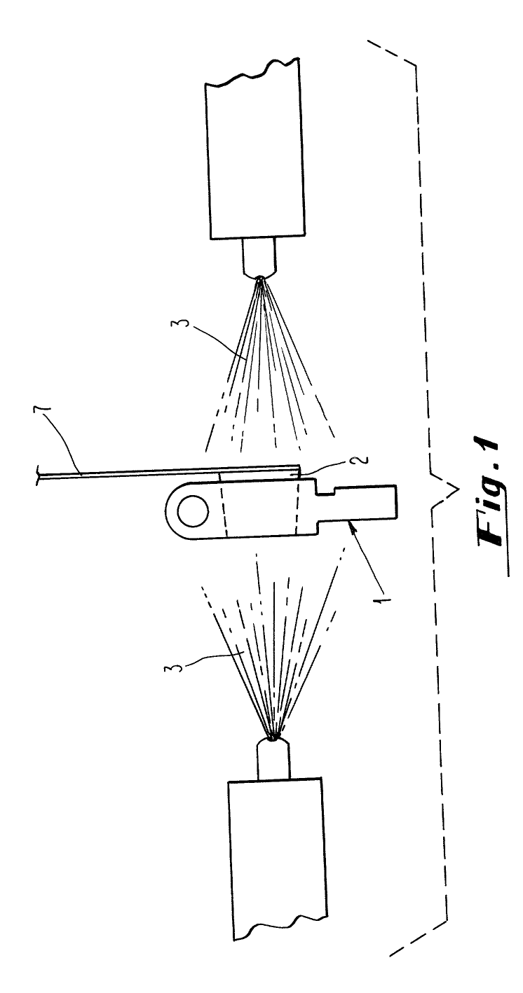

A non-conductive coating can be applied by several methods. One method is to pass the terminal through a fluidized bed and then bake on the coating. Another method is to dip the terminal into a liquid bath. The preferred technique is to use an electrostatic spray system. FIG. 1 shows the typical set-up when applying an electrostatic coating. A terminal (1) is secured to a charged post (2), which has the general shape of a battery post, and is hung from a wire hanger (7). A non-conductive material (3), to be used as a coating, is selected. This can be any material usually applied as an electrostatic coating, including but not limited to a polyester, a polyurethane, or an epoxy. In the preferred embodiment, polyester has been chosen. The non-conductive material (3) is atomized by spray nozzles and charged to the opposite polarity of the charged post (2). Since the electrically conductive terminal (1) has the same charge as the post (2), the oppositely charged non-conductive material (3) is attracted and deposited onto the terminal (1). Any material that is not deposited onto the terminal is 100% reclaimable.

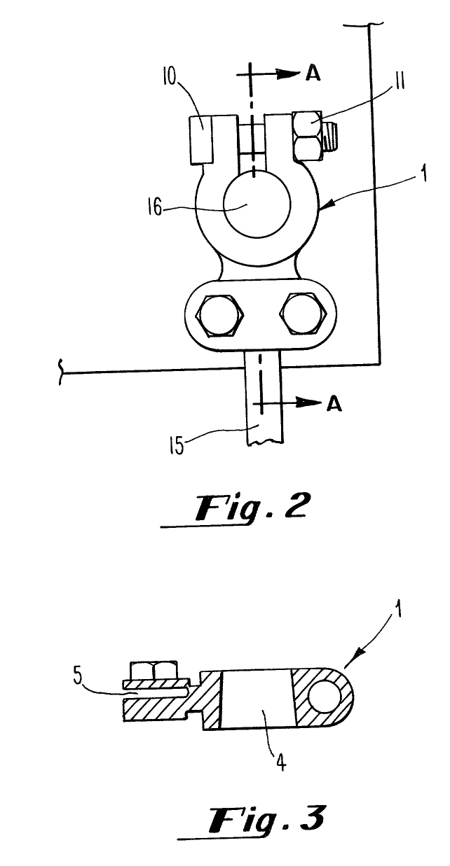

The terminal is then baked so that the coating is permanently bonded to the surface of the terminal. FIGS. 2 and 3 show the battery terminal (1) after the coating has been bonded. A battery post contact area (4) and a battery cable contact area (5) are not coated. This allows electrical conductivity between the post, terminal, and cable.

When the battery terminal (1) is secured around a battery post (16) by a bolt (10) and a nut (11), the post contact area (4) is completely covered and there is no exposed surface area of the terminal. When a battery cable (15) is connected to the terminal (1) by screws or by crimping, the cable contact area (5) is not exposed and, therefore, not subject to corrosion. The life of the battery terminal is prolonged since no surface of the battery terminal is exposed to corrosive elements.

Different color materials (usually red and black) can be used, or dyes can be added to the non-conductive material so as to visually distinguish the battery terminal polarities. This color-coding minimizes any errors associated with connecting the proper cable to the battery during the initial installation or when the identification of the correct polarity is important.

The coating requires no maintenance and the inherent properties associated with the non-conductive materials allow quick clean-ups. In automobiles, the “under the hood” appearance is also improved by not having dirty, corroding terminals detracting from the general appearance.

I claim:

1. A battery terminal, which comprises:
an electrically conductive connector; and,
a coating of non-conductive material on the surfaces of the connector which do not contact a battery post or cable.

2. A battery terminal of claim 1, wherein the non-conductive coating is color-coded.

3. A battery terminal of claim 1, wherein the non-conductive coating is an electrostatic coating.

4. A battery terminal of claim 1, wherein the non-conductive coating is made of polyester.

5. A battery terminal of claim 1, wherein the non-conductive coating is made of polyurethane.

6. A battery terminal of claim 1, wherein the non-conductive coating is made of epoxy.
